(19) United States
(12) Patent Application Publication
(10) Pub. No.: US 2006/0227109 A1
(43) Pub. Date: Oct. 12, 2006

(54) Computer mouse with changeable holding part

(76) Inventor: Heng Ju Lo, Taipei (TW)

Correspondence Address: G. LINK Co., LTD, 3550 Bell Road,, MINOOKA, IL, 60447, US

(21) Appl. No.: 11/094,726

(22) Filed: Mar. 31, 2005

(51) Int. Cl. G09G 5/08

(52) U.S. Cl. 345/163

(57) ABSTRACT

The present invention relates to a computer mouse with changeable holding part, including a body, an upper case and a location changing mechanism. The upper case is covered on the top surface of the body and can change locations. The location changing mechanism is for engaging the upper case and the body and allows the upper case to cover the top surface of the body, as well as allows the upper case to change the engaging location with the body and be engaged together at the new location after the change.

### FIELD OF THE INVENTION

The present invention relates to a computer mouse, in particular, a computer mouse with a changeable holding part.

### BACKGROUND OF THE INVENTION

The upper case of the conventional computer mouse, namely the part where the palm operates the mouse, is presented with an unchangeable holding part positioned on the body. This type of computer mouse obviously cannot satisfy the ergonomics for different users. Because different users have different palm sizes, a holding part that cannot change its location cannot overcome the difference between different palm sizes.

Based on the above-mentioned drawbacks, the inventor of the present invention developed an improved computer mouse with a changeable holding part so as to reduce the difference in holding the mouse due to different palm sizes.

### SUMMARY OF THE INVENTION

The first object of the present invention is to provide a holding part that can change its location so that users with different palm sizes can all use the same computer mouse.

The second object of the present invention is to provide a holding part that satisfies the ergonomics of the computer mouse.

In order to accomplish the above objects, the present invention provides a computer mouse with a changeable holding part, including a body; an upper case disposed on the top surface of the body; a location changing mechanism for engaging the upper case and the body, so that the upper case can cover the top surface of the body and that the upper case can change the engaging location with the body as well as be engaged together with the body at the new location after the change.

### BRIEF DESCRIPTION OF THE DRAWINGS

The above objects and advantages of the present invention will become more apparent with reference to the appended drawings wherein:

FIG. 1 shows an elevational view of a normal position of a computer mouse for use with a changeable holding position in accordance with the present invention;

FIG. 2 shows an elevational view of a position for use after changing the holding part of the computer mouse with a changeable holding position in accordance with the present invention;

FIG. 3 shows an exploded view of the claspers of the location changing mechanism provided on the bottom of the upper case in accordance with the present invention; and

FIG. 4 shows engaging grooves of the location changing mechanism provided on the bottom of the upper case in accordance with the present invention.

### DETAILED DESCRIPTION OF THE INVENTION

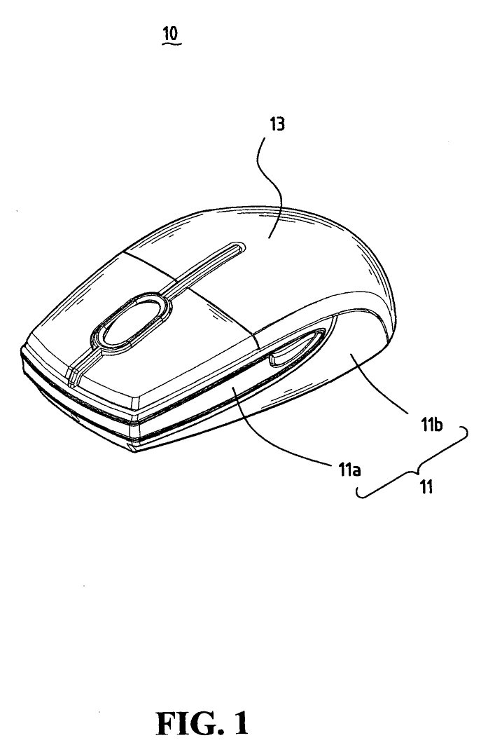

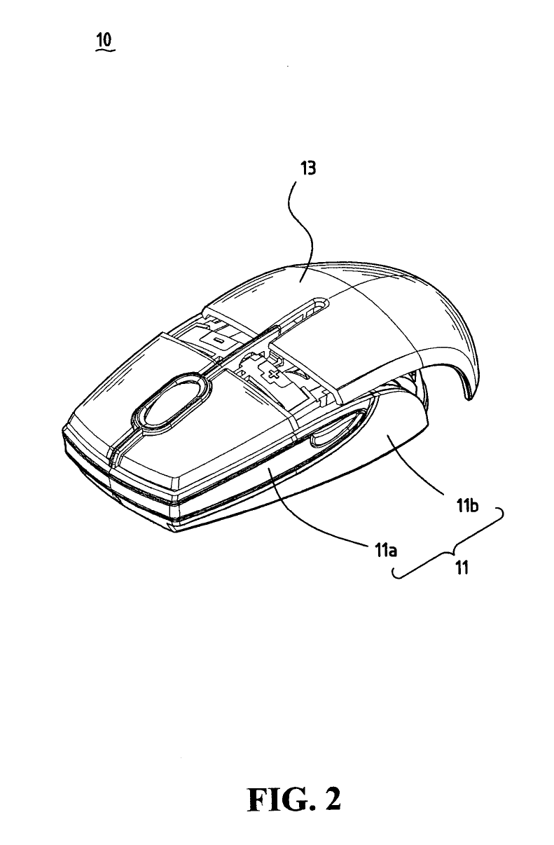

FIG. 1 shows an elevational view of a normal position of a computer mouse for use with a changeable holding position in accordance with the present invention, and FIG. 2 shows an elevational view of a position for use after changing the holding part of the computer mouse with a changeable holding position in accordance with the present invention. The computer mouse 10 in accordance with the present invention emphasizes on a holding part 13 that can change the location thereof. The holding part 13 changes from the original normal location, as shown in the position of FIG. 1, to another location, as shown in the position of FIG. 2. Therefore, the computer mouse 10 in accordance with the present invention can be adjusted based on the palm size of different users so as to satisfy the ergonomics of the computer mouse.

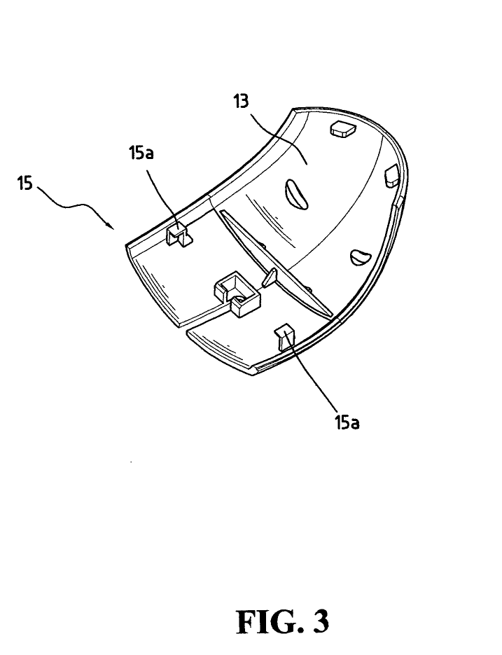

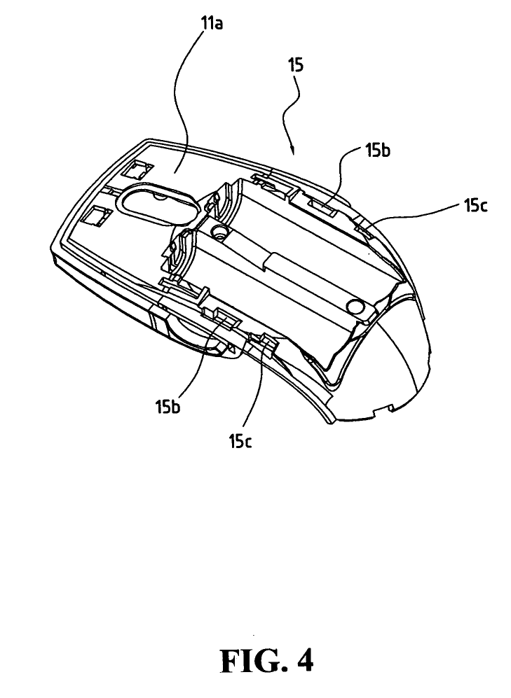

FIG. 3 shows an exploded view of the claspers of the location changing mechanism provided on the bottom of the upper case in accordance with the present invention, and FIG. 4 shows engaging grooves of the location changing mechanism provided on the bottom of the upper case in accordance with the present invention. The computer mouse 10 in accordance with the present invention includes a body 11, an upper case 13, and a location changing mechanism 15, each described as follow. An embodiment of the body 11 consists of an upper body 11a and a lower body 11b. The upper body 11a and the lower body 11b can be engaged by screwing together with screwing means. The upper case 13 is covered on the top surface of the body 11, namely to cover the top surface of the upper body 11a. The main function of the location changing mechanism 15 is to allow the upper case 13 to change the engaging location with the body 11, and be engaged together with the body 11 after the change, as well as to allow the upper case 13 to stably cover on the top surface of the body 11 after the change.

In FIGS. 3 and 4, the location changing mechanism 15 includes claspers 15a, first engaging grooves 15b, and second engaging grooves 15c. A pair of claspers 15a standing across each other is disposed on the bottom of the upper case 13. A pair of first engaging grooves 15b across each other, and a pair of second engaging grooves 15c across each other are disposed on the top surface of the upper body 11a respectively. When the claspers 15a extend into the first engaging grooves 15b and are engaged, the computer mouse 10 is presented as the position shown in FIG. 1. In addition, when the claspers 15a extend into the second engaging grooves 15c, and are engaged, the computer mouse 10 is presented as the position shown in FIG. 2

The embodiment of the location changing mechanism 15 disclosed in the present invention is implemented in accordance with the spirit of the computer mouse 10 with the changeable holding part. As those skilled in the art understand the structure of the location changing mechanism 15 in accordance with the presentation, the number of engaging grooves can be increased so that the upper case 13 can change more locations. Alternatively, those skilled in the art can adopt other means to implement the location changing mechanism 15 after those skilled in the art understand the structure of the computer mouse 10 with a changeable holding part in accordance with the presentation. However, such changes and modification are within the scope of the present invention.

The computer mouse 10 in accordance with the present invention is implemented as a wireless mouse, such as a wireless optical mouse, a wireless USB mouse, a wireless PS2 mouse, a wireless roller mouse, etc.

The computer mouse in accordance with the present invention has the following advantages:

1. The upper case of the present invention is characterized in its changeable location so that the holding part can be adjusted so as to satisfy the ergonomics of the computer mouse, allowing users with different palm sizes to all use the same computer mouse; and

2. Since the location changing mechanism of the present invention is easily operable, a typical user can easily change the location of the upper case, suitable for a computer environment having all family members using one single computer mouse.

Although the present invention has been disclosed above in terms of a preferred embodiment; however, it is not intended to limit the present invention. Some changes and modifications can be made by those skilled in the art without leaving the spirit and scope of the present invention. The scope of the present invention is set forth by the following claims.

What is claimed is:

1. A computer mouse with a changeable holding part, comprising:
a body;
an upper case covered a top surface of said body;
a location changing mechanism for engaging said upper case and said body so that said upper case can cover said top surface of said body, and that said upper case can change an engaging location with said body as well as be engaged together with said body after the change.

2. The computer mouse of claim 1, wherein a portion of said location changing mechanism is disposed on said top surface of said body, and another portion of said location changing mechanism is disposed on the bottom of said upper case.

3. The computer mouse of claim 1, wherein said location changing mechanism comprises:
a pair of corresponding claspers disposed on the bottom of said upper case;
a first engaging groove disposed on said top surface of said body for engaging with said pair of claspers respectively;
a second engaging groove disposed on said top surface of said body for engaging with said pair of claspers respectively.

4. The computer mouse of claim 3, wherein said first engaging groove is disposed on said top surface of said upper case; wherein said second engaging groove is disposed on said top surface of said upper case.

5. The computer mouse of claim 1, wherein said computer mouse is a wireless mouse.
